(19) United States
(12) Patent Application Publication
(10) Pub. No.: US 2012/0024703 A1
(43) Pub. Date: Feb. 2, 2012

(54) COMPOSITIONS USEFUL FOR ELECTROCOATING METAL SUBSTRATES AND ELECTRODEPOSITION PROCESSES USING THE COATINGS

(75) Inventor: James E. Poole, Allegheny County, PA (US)

(73) Assignee: PPG Industries Ohio, Inc., Cleveland, OH (US)

(21) Appl. No.: 12/844,854

(22) Filed: Jul. 28, 2010

(51) Int. Cl. C09D 5/44; C08L 63/00; C08K 5/378

(52) U.S. Cl. 204/507; 524/83; 523/453

(57) ABSTRACT

A curable, electrodepositable coating composition is provided, comprising:
(1) a resin component containing an active hydrogen-containing, cationic salt group-containing resin comprising an acrylic, polyester, polyurethane and/or polyepoxide polymer;
(2) an at least partially capped polyisocyanate curing agent; and
(3) an additive composition comprising 2-mercaptobenzothiazole dispersed in a polymeric component.

Also provided are processes for coating a substrate using the above composition, and methods of preparing the composition.

### STATEMENT REGARDING FEDERALLY SPONSORED RESEARCH OR DEVELOPMENT

This invention was developed with support by the United States Government under agreement number W15QKN-07-C-0048 awarded by the Air Force Research Laboratories (AFRL). The United States Government has certain rights in the invention.

### FIELD OF THE INVENTION

The present invention relates to curable, electrodepositable coating compositions, processes for coating a substrate using the compositions, and methods of preparing the compositions.

### BACKGROUND OF THE INVENTION

The application of a coating by electrodeposition involves depositing a film-forming composition to an electrically conductive substrate under the influence of an applied electrical potential. Electrodeposition has gained prominence in the coatings industry because in comparison with non-electrophoretic coating methods, electrodeposition provides higher paint utilization, corrosion resistance, and low environmental contamination. Early attempts at commercial electrodeposition processes used anionic electrodeposition, where the workpiece being coated served as the anode. However, in 1972, cationic electrodeposition was introduced commercially. Since that time, cationic electrodeposition has become increasingly popular and today is the most prevalent method of electrodeposition. Throughout the world, more than 80 percent of all motor vehicles manufactured are given a primer coating by cationic electrodeposition.

The use of corrosion inhibitors in electrodepositable compositions has provided additional protection to substrates that are coated therewith. However, evolving government regulations have led to the phasing out of certain corrosion inhibitors and other additives in coating compositions, making the production of effective coating compositions challenging.

It would be desirable to provide an electrodepositable composition which demonstrates enhanced corrosion resistance using alternative corrosion inhibitors without loss of cured film properties or appearance.

### SUMMARY OF THE INVENTION

The present invention provides a curable, electrodepositable coating composition, comprising:

(1) a resin component containing an active hydrogen-containing, cationic salt group-containing resin comprising an acrylic, polyester, polyurethane and/or polyepoxide polymer;

(2) an at least partially capped polyisocyanate curing agent; and

(3) an additive composition comprising 2-mercaptobenzothiazole dispersed in a polymeric component.

Additionally provided is a process for preparing the composition, the process comprising:

(1) combining (i) a resin component containing an active hydrogen-containing, cationic salt group-containing resin comprising an acrylic, polyester, polyurethane and/or polyepoxide polymer, with (ii) an at least partially capped polyisocyanate curing agent to form a reactive mixture;

(2) adding to the reactive mixture an additive composition comprising 2-mercaptobenzothiazole dispersed in a polymeric component;

(3) adding a catalyst composition to the reactive mixture; and

(4) diluting the reactive mixture with water to a solids content of 10 to 30 percent by weight, based on the total weight of the reactive mixture.

Also provided is a process for applying a coating to a metal substrate comprising:

(a) electrophoretically depositing on the substrate a curable, electrodepositable coating composition comprising:
(1) a resin component containing an active hydrogen-containing, cationic salt group-containing resin electrodepositable on a cathode and comprising an acrylic, polyester, polyurethane and/or polyepoxide polymer;
(2) an at least partially capped polyisocyanate curing agent; and
(3) an additive composition comprising 2-mercaptobenzothiazole dispersed in a polymeric component; and

(b) heating the substrate to a temperature and for a time sufficient to effect cure of the electrodepositable composition.

### DETAILED DESCRIPTION

Other than in the operating examples, or unless otherwise expressly specified, all of the numerical ranges, amounts, values and percentages such as those for amounts of materials, times and temperatures of reaction, ratios of amounts, values for molecular weight (whether number average molecular weight (“Mₙ”) or weight average molecular weight (“M_{w}”)), and others in the following portion of the specification may be read as if prefaced by the word “about” even though the term “about” may not expressly appear with the value, amount or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Plural referents as used herein encompass singular and vice versa. For example, while the invention has been described in terms of “a” cationic acrylic resin derived from an epoxy functional acrylic resin, a plurality, including a mixture of such resins can be used.

Any numeric references to amounts, unless otherwise specified, are “by weight”. The term “equivalent weight” is a calculated value based on the relative amounts of the various ingredients used in making the specified material and is based on the solids of the specified material. The relative amounts are those that result in the theoretical weight in grams of the material, like a polymer, produced from the ingredients and give a theoretical number of the particular functional group that is present in the resulting polymer. The theoretical polymer weight is divided by the theoretical number of equivalents of functional groups to give the equivalent weight. For example, urethane equivalent weight is based on the equivalents of urethane groups in the polyurethane material.

As used herein, the term “polymer” is meant to refer to prepolymers, oligomers and both homopolymers and copolymers; the prefix “poly” refers to two or more.

Also for molecular weights, whether number average (Mₙ) or weight average (M_{w}), these quantities are determined by gel permeation chromatography using polystyrene as standards as is well known to those skilled in the art and such as is discussed in U.S. Pat. No. 4,739,019, at column 4, lines 2-45.

As used herein “based on total weight of the resin solids” of the composition means that the amount of the component added during the formation of the composition is based upon the total weight of the resin solids (non-volatiles) of the film forming materials, polyurethanes, cross-linkers, and polymers present during the formation of the composition, but not including any water, solvent, or any additive solids such as hindered amine stabilizers, photoinitiators, pigments including extender pigments and fillers, flow modifiers, catalysts, and UV light absorbers.

As used herein, “formed from” denotes open, e.g., “comprising,” claim language. As such, it is intended that a composition “formed from” a list of recited components be a composition comprising at least these recited components, and can further comprise other non-recited components during the composition's formation.

The curable, electrodepositable coating composition comprises a resin component (1) containing an active hydrogen-containing, cationic salt group-containing resin that is electrodepositable on a cathode. The active hydrogen-containing, cationic salt group-containing resin may be prepared from an acrylic, polyester, polyurethane and/or polyepoxide polymer.

Suitable acrylic polymers that may be used as the active hydrogen-containing, cationic salt group-containing resin include copolymers of one or more alkyl esters of acrylic acid or methacrylic acid optionally together with one or more other polymerizable ethylenically unsaturated monomers. Suitable alkyl esters of acrylic acid or methacrylic acid include methyl methacrylate, ethyl methacrylate, butyl methacrylate, ethyl acrylate, butyl acrylate, and 2-ethyl hexyl acrylate. Suitable other copolymerizable ethylenically unsaturated monomers include nitriles such acrylonitrile and methacrylonitrile, vinyl and vinylidene halides such as vinyl chloride and vinylidene fluoride and vinyl esters such as vinyl acetate. Acid and anhydride functional ethylenically unsaturated monomers such as acrylic acid, methacrylic acid or anhydride, itaconic acid, maleic acid or anhydride, or fumaric acid may be used. Amide functional monomers including, acrylamide, methacrylamide, and N-alkyl substituted (meth)acrylamides are also suitable. Vinyl aromatic compounds such as styrene and vinyl toluene are also suitable.

Functional groups such as hydroxyl and amino groups may be incorporated into the acrylic polymer by using functional monomers such as hydroxyalkyl acrylates and methacrylates or aminoalkyl acrylates and methacrylates. Tertiary amino groups (for conversion to cationic salt groups) may be incorporated into the acrylic polymer by using dialkylaminoalkyl(meth)acrylate functional monomers such as dimethylaminoethyl methacrylate, diethylaminoethyl methacrylate, dipropylaminoethyl methacrylate, and the like.

Epoxide functional groups (for conversion to cationic salt groups) may be incorporated into the acrylic polymer by using functional monomers such as glycidyl acrylate and methacrylate, 3,4-epoxycyclohexylmethyl(meth)acrylate, 2-(3,4-epoxycyclohexyl)ethyl(meth)acrylate, or allyl glycidyl ether. Alternatively, epoxide functional groups may be incorporated into the acrylic polymer by reacting hydroxyl groups on the acrylic polymer with an epihalohydrin or dihalohydrin such as epichlorohydrin or dichlorohydrin in the presence of alkali.

The acrylic polymer may be prepared by traditional free radical initiated polymerization techniques, such as solution or emulsion polymerization, as known in the art using suitable catalysts which include organic peroxides and azo type compounds and optionally chain transfer agents such as alpha-methyl styrene dimer and tertiary dodecyl mercaptan.

Besides acrylic polymers, the active hydrogen-containing, cationic salt group-containing resin may be a polyester. The polyesters may be prepared in a known manner by condensation of polyhydric alcohols and polycarboxylic acids. Suitable polyhydric alcohols include, for example, ethylene glycol, propylene glycol, butylene glycol, 1,6-hexylene glycol, neopentyl glycol, diethylene glycol, glycerol, trimethylol propane, and pentaerythritol.

Examples of suitable polycarboxylic acids used to prepare the polyester include succinic acid, adipic acid, azelaic acid, sebacic acid, maleic acid, fumaric acid, phthalic acid, tetrahydrophthalic acid, hexahydrophthalic acid, and trimellitic acid. Besides the polycarboxylic acids mentioned above, functional equivalents of the acids such as anhydrides where they exist or lower alkyl esters of the acids such as the methyl esters may be used.

The polyesters contain a portion of free hydroxyl groups (done by using excess polyhydric alcohol and/or higher polyols during preparation of the polyester) which are available for crosslinking reactions.

Epoxide functional groups may be incorporated into the polyester by reacting hydroxyl groups on the polyester with an epihalohydrin or dihalohydrin such as epichlorohydrin or dichlorohydrin in the presence of alkali.

Alkanolamines and dialkanolamines may be used in combination with the polyols in the preparation of the polyester, and the amine groups later alkylated to form tertiary amino groups for conversion to cationic salt groups. Likewise, tertiary amines such as N,N-dialkylalkanolamines and N-alkyldialkanolamines may be used in the preparation of the polyester. Examples of suitable tertiary amines include those N-alkyl dialkanolamines disclosed in U.S. Pat. No. 5,483,012, at column 3, lines 49-63. Suitable polyesters for use in the process of the present invention include those disclosed in U.S. Pat. No. 3,928,157.

Polyurethanes can also be used as the active hydrogen-containing, cationic salt group-containing resin. Among the polyurethanes which can be used are polymeric polyols which are prepared by reacting polyester polyols or acrylic polyols such as those mentioned above with a polyisocyanate such that the OH/NCO equivalent ratio is greater than 1:1 so that free hydroxyl groups are present in the product. Smaller polyhydric alcohols such as those disclosed above for use in the preparation of the polyester may also be used in place of or in combination with the polymeric polyols.

The organic polyisocyanate used to prepare the polyurethane polymer is often an aliphatic polyisocyanate. Diisocyanates and/or higher polyisocyanates are suitable.

Examples of suitable aliphatic diisocyanates are straight chain aliphatic diisocyanates such as 1,4-tetramethylene diisocyanate and 1,6-hexamethylene diisocyanate. Also, cycloaliphatic diisocyanates can be employed. Examples include isophorone diisocyanate and 4,4′-methylene-bis-(cyclohexyl isocyanate). Examples of suitable aralkyl diisocyanates are meta-xylylene diisocyanate and α,α,α′,α′-tetramethylmeta-xylylene diisocyanate.

Isocyanate prepolymers, for example, reaction products of polyisocyanates with polyols such as neopentyl glycol and trimethylol propane or with polymeric polyols such as polycaprolactone diols and triols (NCO/OH equivalent ratio greater than one) can also be used in the preparation of the polyurethane.

Hydroxyl functional tertiary amines such as N,N-dialkylalkanolamines and N-alkyl dialkanolamines may be used in combination with the other polyols in the preparation of the polyurethane. Examples of suitable tertiary amines include those N-alkyl dialkanolamines disclosed in U.S. Pat. No. 5,483,012, at column 3, lines 49-63.

Epoxide functional groups may be incorporated into the polyurethane by reacting hydroxyl groups on the polyurethane with an epihalohydrin or dihalohydrin such as epichlorohydrin or dichlorohydrin in the presence of alkali.

Suitable polyepoxides polymers for use as the active hydrogen-containing, cationic salt group-containing resin include, for example, a polyepoxide chain-extended by reacting together a polyepoxide and a polyhydroxyl group-containing material such as alcoholic hydroxyl group-containing materials and phenolic hydroxyl group-containing materials to chain extend or build the molecular weight of the polyepoxide.

A chain-extended polyepoxide is typically prepared by reacting together the polyepoxide and polyhydroxyl group-containing material neat or in the presence of an inert organic solvent such as a ketone, including methyl isobutyl ketone and methyl amyl ketone, aromatics such as toluene and xylene, and glycol ethers such as the dimethyl ether of diethylene glycol. The reaction is usually conducted at a temperature of about 80° C. to 160° C. for about 30 to 180 minutes until an epoxy group-containing resinous reaction product is obtained.

The equivalent ratio of reactants; i.e., epoxy:polyhydroxyl group-containing material is typically from about 1.00:0.75 to 1.00:2.00.

The polyepoxide by definition has at least two 1,2-epoxy groups. In general the epoxide equivalent weight of the polyepoxide will range from 100 to about 2000, typically from about 180 to 500. The epoxy compounds may be saturated or unsaturated, cyclic or acyclic, aliphatic, alicyclic, aromatic or heterocyclic. They may contain substituents such as halogen, hydroxyl, and ether groups.

Examples of polyepoxides are those having a 1,2-epoxy equivalency greater than one and usually about two; that is, polyepoxides which have on average two epoxide groups per molecule. The most commonly used polyepoxides are polyglycidyl ethers of cyclic polyols, for example, polyglycidyl ethers of polyhydric phenols such as Bisphenol A, resorcinol, hydroquinone, benzenedimethanol, phloroglucinol, and catechol; or polyglycidyl ethers of polyhydric alcohols such as alicyclic polyols, particularly cycloaliphatic polyols such as 1,2-cyclohexane diol, 1,4-cyclohexane diol, 2,2-bis(4-hydroxycyclohexyl)propane, 1,1-bis(4-hydroxycyclohexyl)ethane, 2-methyl-1,1-bis(4-hydroxycyclohexyl)propane, 2,2-bis(4-hydroxy-3-tertiarybutylcyclohexyl)propane, 1,3-bis(hydroxymethyl)cyclohexane and 1,2-bis(hydroxymethyl)cyclohexane. Examples of aliphatic polyols include, inter alia, trimethylpentanediol and neopentyl glycol.

Polyhydroxyl group-containing materials used to chain extend or increase the molecular weight of the polyepoxide may additionally be polymeric polyols such as those disclosed above.

The polyepoxides may alternatively be acrylic polymers prepared with epoxy functional monomers such as glycidyl acrylate, glycidyl methacrylate, allyl glycidyl ether, and methallyl glycidyl ether. Polyesters, polyurethanes, or polyamides prepared with glycidyl alcohols or glycidyl amines, or reacted with an epihalohydrin are also suitable epoxy functional resins.

The resins used in the electrodepositable composition typically have number average molecular weights ranging from about 180 to 500, often from about 186 to 350.

The resin used in the composition of the present invention contains cationic salt groups. The cationic salt groups may be incorporated into the resin by any means know in the art depending on the type of resin and/or active hydrogen group, such as by acidifying tertiary amine groups in the resin as described below or by reacting epoxide groups in the resin with a cationic salt group former. By “cationic salt group former” is meant a material which is reactive with epoxy groups and which can be acidified before, during, or after reaction with epoxy groups to form cationic salt groups. Examples of suitable materials include amines such as primary or secondary amines which can be acidified after reaction with the epoxy groups to form amine salt groups, or tertiary amines which can be acidified prior to reaction with the epoxy groups and which after reaction with the epoxy groups form quaternary ammonium salt groups. Examples of other cationic salt group formers are sulfides that can be mixed with acid prior to reaction with the epoxy groups and form ternary sulfonium salt groups upon subsequent reaction with the epoxy groups.

When amines are used as the cationic salt formers, monoamines are often used, and hydroxyl-containing amines are particularly suitable. Polyamines may be used but are not recommended because of a tendency to gel the resin.

In a typical embodiment of the invention, the cationic salt group-containing resin contains amine salt groups, which are derived from an amine containing a nitrogen atom to which is bonded at least one, usually two, alkyl groups having a hetero atom in a beta-position relative to the nitrogen atom. A hetero atom is a non-carbon or non-hydrogen atom, typically oxygen, nitrogen, or sulfur.

Hydroxyl-containing amines, when used as the cationic salt group formers, may impart the resin with amine groups comprising a nitrogen atom to which is bonded at least one alkyl group having a hetero atom in a beta-position relative to the nitrogen atom. Examples of hydroxyl-containing amines are alkanolamines, dialkanolamines, alkyl alkanolamines, and aralkyl alkanolamines containing from 1 to 18 carbon atoms, usually 1 to 6 carbon atoms in each of the alkanol, alkyl and aryl groups. Specific examples include ethanolamine, N-methylethanolamine, diethanolamine, N-phenylethanolamine, N,N-dimethylethanolamine, N-methyldiethanolamine, triethanolamine and N-(2-hydroxyethyl)-piperazine.

Minor amounts of amines such as mono, di, and trialkylamines and mixed aryl-alkyl amines which do not contain hydroxyl groups, or amines substituted with groups other than hydroxyl which do not negatively affect the reaction between the amine and the epoxy may also be used, but their use is not preferred. Specific examples include ethylamine, methylethylamine, triethylamine, N-benzyldimethylamine, dicocoamine and N,N-dimethylcyclohexylamine.

The reaction of a primary and/or secondary amine with epoxide groups on the polymer takes place upon mixing of the amine and polymer. The amine may be added to the polymer or vice versa. The reaction can be conducted neat or in the presence of a suitable solvent such as methyl isobutyl ketone, xylene, or 1-methoxy-2-propanol. The reaction is generally exothermic and cooling may be desired. However, heating to a moderate temperature of about 50 to 150° C. may be done to hasten the reaction.

The tertiary amine functional polymer (or the reaction product of the primary and/or secondary amine and the epoxide functional polymer) is rendered cationic and water dispersible by at least partial neutralization with an acid. Suitable acids include organic and inorganic acids such as formic acid, acetic acid, lactic acid, phosphoric acid, dimethylolpropionic acid, and sulfamic acid. Lactic acid is used most often. The extent of neutralization varies with the particular reaction product involved. However, sufficient acid should be used to disperse the electrodepositable composition in water. Typically, the amount of acid used provides at least 20 percent of all of the total neutralization. Excess acid may also be used beyond the amount required for 100 percent total neutralization.

In the reaction of a tertiary amine with an epoxide functional polymer, the tertiary amine can be pre-reacted with the neutralizing acid to form the amine salt and then the amine salt reacted with the polymer to form a quaternary salt group-containing resin. The reaction is conducted by mixing the amine salt with the polymer in water. Typically the water is present in an amount ranging from about 1.75 to about 20 percent by weight based on total reaction mixture solids.

In forming the quaternary ammonium salt group-containing resin, the reaction temperature can be varied from the lowest temperature at which the reaction will proceed, generally at or slightly above room temperature, to a maximum temperature of about 100° C. (at atmospheric pressure). At higher pressures, higher reaction temperatures may be used. Usually the reaction temperature is in the range of about 60 to 100° C. Solvents such as a sterically hindered ester, ether, or sterically hindered ketone may be used, but their use is not necessary.

In addition to the primary, secondary, and tertiary amines disclosed above, a portion of the amine that is reacted with the polymer can be a ketimine of a polyamine, such as is described in U.S. Pat. No. 4,104,147, column 6, line 23 to column 7, line 23. The ketimine groups decompose upon dispersing the amine-epoxy reaction product in water.

In addition to resins containing amine salts and quaternary ammonium salt groups, cationic resins containing ternary sulfonium groups may be used in forming the cationic salt group-containing resin. Examples of these resins and their method of preparation are described in U.S. Pat. Nos. 3,793,278 to DeBona and 3,959,106 to Bosso et al., incorporated herein by reference.

The extent of cationic salt group formation should be such that when the resin is mixed with an aqueous medium and the other ingredients, a stable dispersion of the electrodepositable composition will form. By “stable dispersion” is meant one that does not settle or is easily redispersible if some settling occurs. Moreover, the dispersion should be of sufficient cationic character that the dispersed particles will migrate toward and electrodeposit on a cathode when an electrical potential is set up between an anode and a cathode immersed in the aqueous dispersion.

Generally, the cationic resin is non-gelled and contains from about 0.1 to 3.0, often from about 0.1 to 0.7 millequivalents of cationic salt group per gram of resin solids. By “non-gelled” is meant that the resin is substantially free from crosslinking, and prior to cationic salt group formation, the resin has a measurable intrinsic viscosity when dissolved in a suitable solvent. In contrast, a gelled resin, having an essentially infinite molecular weight, would have an intrinsic viscosity too high to measure.

The active hydrogens associated with the cationic resin include any active hydrogens which are reactive with isocyanates within the temperature range of about 93 to 204° C., usually about 121 to 177° C. Typically, the active hydrogens comprise hydroxyl and primary and secondary amino, including mixed groups such as hydroxyl and primary amino. Typically, the resin will have an active hydrogen content of about 1.7 to 10 millequivalents, more often about 2.0 to 5 millequivalents of active hydrogen per gram of resin solids.

In certain embodiments, the resin component (1) further comprises a microgel derived from a polyepoxide. A particularly useful microgel is illustrated in Example 3 below.

The cationic salt group-containing resin is typically present in the electrodepositable composition of the present invention in an amount of 50 to 90 percent, often 55 to 75 percent by weight, based on the total weight of the cationic salt group-containing resin and the curing agent.

The polyisocyanate curing agent (2) used in the electrodepositable composition is at least partially capped. Often the polyisocyanate curing agent is a fully capped polyisocyanate with substantially no free isocyanate groups. The polyisocyanate can be an aliphatic or an aromatic polyisocyanate or a mixture of the two. Diisocyanates are used most often, although higher polyisocyanates can be used in place of or in combination with diisocyanates.

Examples of polyisocyanates suitable for use as curing agents include all those disclosed above as suitable for use in the preparation of the polyurethane. In a particular embodiment, the polyisocyanate is isophorone diisocyanate capped with trimethylol propane and/or methyl ethyl ketoxime.

Any suitable aliphatic, cycloaliphatic, or aromatic alkyl monoalcohol or phenolic compound may be used as a capping agent for the polyisocyanate including, for example, lower aliphatic alcohols such as methanol, ethanol, and n-butanol; cycloaliphatic alcohols such as cyclohexanol; aromatic-alkyl alcohols such as phenyl carbinol and methylphenyl carbinol; and phenolic compounds such as phenol itself and substituted phenols wherein the substituents do not affect coating operations, such as cresol and nitrophenol. Glycol ethers may also be used as capping agents. Suitable glycol ethers include ethylene glycol butyl ether, diethylene glycol butyl ether, ethylene glycol methyl ether and propylene glycol methyl ether.

Other suitable capping agents include oximes such as methyl ethyl ketoxime, acetone oxime and cyclohexanone oxime, lactams such as epsilon-caprolactam, and amines such as dibutyl amine.

The polyisocyanate curing agent (2) is typically present in the electrodepositable composition of the present invention in an amount of 10 to 50 percent, often 25 to 45 percent by weight, based on the total weight of the cationic salt group-containing resin and the curing agent.

The composition of the present invention further comprises (3) an additive composition comprising 2-mercaptobenzothiazole dispersed in a polymeric component. By “dispersed” is meant that the 2-mercaptobenzothiazole is distributed throughout the polymeric component. The 2-mercaptobenzothiazole may be dispersed in the polymeric component using any known means. For example, it is typically dispersed in the polymeric component by a grinding or milling process.

The polymeric component in the additive composition (3) may comprise an acrylic, a polyester, a polyurethane, a polyether, and/or a polyepoxide. Acrylics, polyesters, polyepoxides and polyurethanes may be any of those disclosed above, with or without cationic salt groups. Typically, the polymeric component comprises a resin that is suitable for use as a pigment grind vehicle.

Examples of polyether polymers are polyalkylene ether polyols which include those having the following structural formula:

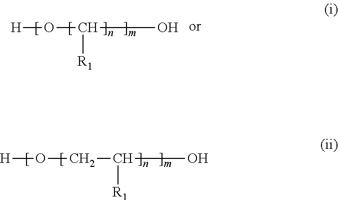

where the substituent R₁ is hydrogen or lower alkyl containing from 1 to 5 carbon atoms including mixed substituents, and n is typically from 2 to 6 and m is from 8 to 100 or higher. Included are poly(oxytetramethylene) glycols, poly(oxytetraethylene) glycols, poly(oxy-1,2-propylene) glycols, and poly(oxy-1,2-butylene) glycols.

Also useful are polyether polyols formed from oxyalkylation of various polyols, for example, diols such as ethylene glycol, 1,6-hexanediol, Bisphenol A and the like, or other higher polyols such as trimethylolpropane, pentaerythritol, and the like. Polyols of higher functionality which can be utilized as indicated can be made, for instance, by oxyalkylation of compounds such as sucrose or sorbitol. One commonly utilized oxyalkylation method is reaction of a polyol with an alkylene oxide, for example, propylene or ethylene oxide, in the presence of an acidic or basic catalyst. Particular polyethers include those sold under the names TERATHANE and TERACOL, available from E. I. Du Pont de Nemours and Company, Inc., and POLYMEG, available from Q O Chemicals, Inc., a subsidiary of Great Lakes Chemical Corp.

In a particular embodiment, the polymeric component in the additive composition comprises a polyepoxide derived from EPON 880 (polyepoxide commercially available from Hexion Specialty Chemicals, Inc.) chain extended with BISPHENOL A.

The 2-mercaptobenzothiazole may be dispersed in the polymeric component using high shear mixing or milling techniques. It is usually dispersed using conventional pigment grinding/milling techniques.

In particular embodiments, the additive composition (3) further comprises a pigment. Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

In a particular embodiment, the pigment comprises carbon black, TiO₂, yellow iron oxide, and/or phthalo blue. In this embodiment, the 2-mercaptobenzothiazole is present in the additive composition in an amount of up to 25 percent by weight, often up to 15 and more often up to 10 percent by weight, based on the total weight of pigment solids in the additive composition (3). By “based on the total weight of pigment solids” is meant that only pigments are included in the basis for calculation; the weight of any resins present in the additive composition is not included in the calculation.

The curable, electrodepositable coating composition of the present invention may additionally include optional ingredients commonly used in such compositions. For example, the composition may further comprise a hindered amine light stabilizer for UV degradation resistance. Such hindered amine light stabilizers include those disclosed in U.S. Pat. No. 5,260,135. When they are used they are present in the electrodepositable composition in an amount of 0.1 to 2 percent by weight, based on the total weight of resin solids in the electrodepositable composition. Other optional additives such as surfactants, wetting agents or catalysts can be included in the composition.

Catalysts include those effective for reactions of isocyanates with active hydrogens. The catalysts, which are often solids, are typically dispersed in a conventional pigment grinding vehicle such as those disclosed in U.S. Pat. No. 4,007,154, by a grinding or milling process. As such, they may be added to the electrodepositable composition as a separate component or they may be part of the additive composition (3) that is incorporated into the electrodepositable composition. The catalysts are typically used in amounts of about 0.05 to 2 percent by weight metal based on weight of total solids. Suitable catalysts include tin compounds such as triphenyl tin hydroxide, butyl stannoic acid, dioctyltin oxide, dibutyltin dilaurate, dibutyltin diacetate, and dibutyltin oxide.

The electrodepositable compositions of the present invention are typically prepared as electrodeposition baths, diluted with water. The composition used as an electrodeposition bath in the process of the present invention has a resin solids content usually within the range of about 5 to 30 percent by weight, often 10 to 30 percent by weight or 5 to 25 percent by weight based on total weight of the electrodeposition bath.

Besides water, the aqueous medium of the electrodeposition bath may contain a coalescing solvent. Useful coalescing solvents include hydrocarbons, alcohols, esters, ethers and ketones. The most commonly used coalescing solvents include alcohols, polyols and ketones. Specific coalescing solvents include isopropanol, butanol, 2-ethylhexanol, isophorone, 2-methoxypentanone, ethylene and propylene glycol and the monoethyl, monobutyl and monohexyl ethers of ethylene glycol. The amount of coalescing solvent is generally between about 0.01 and 25 percent and when used, often from about 0.05 to about 5 percent by weight based on total weight of the aqueous medium.

The curable, electrodepositable coating composition of the present invention may be prepared using the following process:

(1) combining (i) the resin component as described above containing one or more of the active hydrogen-containing, cationic salt group-containing resins described earlier with (ii) an at least partially capped polyisocyanate curing agent to form a reactive mixture;

(2) adding to the reactive mixture the additive composition comprising 2-mercaptobenzothiazole dispersed in a polymeric component;

(3) adding a catalyst composition to the reactive mixture; and

(4) diluting the reactive mixture with water to a solids content of 10 to 30 percent by weight, based on the total weight of the reactive mixture. Note that the order of process steps may be altered without departing from the spirit of the invention; for example, the catalyst may be added to the reactive mixture before or simultaneously with (and even as a part of) the additive composition as noted above. However, if the 2-mercaptobenzothiazole is not dispersed in the polymeric component prior to its addition to the reactive mixture, it has been observed that the corrosion inhibiting properties of the coating composition on a substrate coated therewith are not as effective as when the 2-mercaptobenzothiazole is initially dispersed in the polymeric component. In fact, it can be very difficult to incorporate the 2-mercaptobenzothiazole into the reactive mixture without first dispersing it into a polymeric component.

In certain embodiments of the present invention, after diluting the reactive mixture with water to a solids content of up to 30 percent by weight, a portion (usually twenty percent by weight) of the reactive mixture may be removed by ultrafiltration and replaced with deionized water.

The curable, electrodepositable coating compositions may be used in a process for applying a coating to a metal substrate in accordance with the present invention. The process comprises:

(a) electrophoretically depositing on the substrate a curable, electrodepositable coating composition as described above; and

(b) heating the substrate to a temperature and for a time sufficient to effect cure of the electrodepositable composition.

The metal substrates used in the process of the present invention include ferrous metals, non-ferrous metals and combinations thereof. Suitable ferrous metals include iron, steel, and alloys thereof. Non-limiting examples of useful steel materials include cold rolled steel, pickled steel, steel surface-treated with any of zinc metal, zinc compounds and zinc alloys (including electrogalvanized steel, hot-dipped galvanized steel, GALVANNEAL steel, and steel plated with zinc alloy,) and/or zinc-iron alloys. Also, aluminum, aluminum alloys, zinc-aluminum alloys such as GALFAN, GALVALUME, aluminum plated steel and aluminum alloy plated steel substrates may be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in U.S. Pat. Nos. 4,157,924 and 4,186,036. Cold rolled steel is also suitable when pretreated with an appropriate solution known in the art, such as a metal phosphate solution, an aqueous solution containing at least one Group IIIB or IVB metal, an organophosphate solution, an organophosphonate solution, and combinations thereof, as discussed below.

The substrate may alternatively comprise more than one metal or metal alloy in that the substrate may be a combination of two or more metal substrates assembled together such as hot-dipped galvanized steel assembled with aluminum substrates.

The substrates to be used may be bare metal substrates. By “bare” is meant a virgin metal substrate that has not been treated with any pretreatment compositions such as conventional phosphating baths, heavy metal rinses, etc. Additionally, bare metal substrates being treated in the process of the present invention may be a cut edge of a substrate that is otherwise treated and/or coated over the rest of its surface. Alternatively, the substrates may undergo one or more treatment steps known in the art prior to the deposition of the electrodepositable coating composition.

For example, the process may include one or more optional steps, as outlined below:

(a) optionally forming a metal object from the substrate;
(b) optionally cleaning the substrate with an alkaline and/or acidic cleaner;
(c) optionally pretreating the substrate with a solution substantially free of heavy metals and comprising a metal phosphate solution, an aqueous solution containing at least one Group IIIB or IVB metal, an organophosphate solution, an organophosphonate solution, or combinations thereof;
(d) optionally rinsing the substrate with water;
(e) electrophoretically depositing on the substrate the curable, electrodepositable coating composition described above; and
(f) heating the substrate to a temperature and for a time sufficient to effect cure of the electrodepositable composition.

Note that the order of process steps (a) through (f) may be altered with the same results and without departing from the scope of the invention. Also, additional water rinsing steps may be added as necessary.

Before any treatment or electrodeposition, the substrate may optionally be formed into an object of manufacture. As mentioned above, a combination of more than one metal substrate may be assembled together to form an object.

The substrate may then optionally be cleaned using conventional cleaning procedures and materials. These would include mild or strong alkaline cleaners such as are commercially available and conventionally used in metal pretreatment processes. Examples of alkaline cleaners include Chemkleen 163 and Chemkleen 177, both of which are available from PPG Industries, Pretreatment and Specialty Products. Such cleaners are generally followed and/or preceded by a water rinse. The metal surface may also be rinsed with an aqueous acidic solution after or in place of cleaning with the alkaline cleaner. Examples of rinse solutions include mild or strong acidic cleaners such as the dilute nitric acid solutions commercially available and conventionally used in metal pretreatment processes. Rinse solutions containing heavy metals such as chromium are not suitable for use in the process of the present invention.

The metal substrate may optionally be pretreated with any suitable solution known in the art, such as a metal phosphate solution, an aqueous solution containing at least one Group IIIB or IVB metal, an organophosphate solution, an organophosphonate solution, and combinations thereof. The pretreatment solutions may be substantially free of environmentally detrimental heavy metals such as chromium and nickel. Suitable phosphate conversion coating compositions may be any of those known in the art that are free of heavy metals. Examples include zinc phosphate, which is used most often, iron phosphate, manganese phosphate, calcium phosphate, magnesium phosphate, cobalt phosphate, zinc-iron phosphate, zinc-manganese phosphate, zinc-calcium phosphate, and layers of other types, which may contain one or more multivalent cations. Phosphating compositions are known to those skilled in the art and are described in U.S. Pat. Nos. 4,941,930, 5,238,506, and 5,653,790.

The IIIB or IVB transition metals and rare earth metals referred to herein are those elements included in such groups in the CAS Periodic Table of the Elements as is shown, for example, in the Handbook of Chemistry and Physics, 63rd Edition (1983).

Typical group IIIB and IVB transition metal compounds and rare earth metal compounds are compounds of zirconium, titanium, hafnium, yttrium and cerium and mixtures thereof. Typical zirconium compounds may be selected from hexafluorozirconic acid, alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof. Hexafluorozirconic acid is used most often. An example of a titanium compound is fluorotitanic acid and its salts. An example of a hafnium compound is hafnium nitrate. An example of a yttrium compound is yttrium nitrate. An example of a cerium compound is cerous nitrate.

Typical compositions to be used in the pretreatment step include non-conductive organophosphate and organophosphonate pretreatment compositions such as those disclosed in U.S. Pat. Nos. 5,294,265 and 5,306,526. Such organophosphate or organophosphonate pretreatments are available commercially from PPG Industries, Inc. under the name NUPAL®.

Following the optional pretreatment step, the metal substrate may be rinsed with water and then electrocoated. Rinsing ensures that the layer of the non-conductive coating is sufficiently thin to be non-insulating. Electrocoating may be done immediately or after a drying period at ambient or elevated temperature conditions.

In the process of electrodeposition, the metal substrate being coated, serving as an electrode, and an electrically conductive counter electrode are placed in contact with an ionic, electrodepositable composition. Upon passage of an electric current between the electrode and counter electrode while they are in contact with the electrodepositable composition, an adherent film of the electrodepositable composition will deposit in a substantially continuous manner on the metal substrate. In the process of the present invention the metal substrate being coated serves as a cathode, and the electrodepositable composition is cationic.

Electrodeposition is usually carried out at a constant voltage in the range of from about 1 volt to several thousand volts, typically between 50 and 500 volts. Current density is usually between about 1.0 ampere and 15 amperes per square foot (10.8 to 161.5 amperes per square meter) and tends to decrease quickly during the electrodeposition process, indicating formation of a continuous self-insulating film.

After electrodeposition, the coated substrate is heated to cure the deposited composition. The heating or curing operation is usually carried out at a temperature in the range of from 250 to 450° F. (121.1 to 232.2° C.), often 300 to 450° F. (148.9 to 232.2° C.), more often 300 to 400° F. (148.9 to 204.4° C.) for a period of time sufficient to effect cure of the composition, typically ranging from 10 to 60 minutes. The thickness of the resultant film is usually from about 10 to 50 microns. By “cure” is meant a chemical reaction between the active hydrogen-containing, cationic salt group-containing resin and the polyisocyanate curing agent resulting in a substantially crosslinked film.

One or more pigmented color coating compositions and/or transparent coating compositions may be applied directly to the electrodepositable composition after curing of the electrodepositable composition. The use of a primer or primer-surfacer may be unnecessary because of the superior corrosion resistance and UV degradation resistance afforded by the various compositions used in the process of the present invention. Suitable top coats (base coats, clear coats, pigmented monocoats, and color-plus-clear composite compositions) include any of those known in the art, and each may be waterborne, solventborne or powdered. The top coat typically includes a film-forming resin, crosslinking material and pigment (in a colored base coat or monocoat). Non-limiting examples of suitable base coat compositions include waterborne base coats such as are disclosed in U.S. Pat. Nos. 4,403,003; 4,147,679; and 5,071,904. Suitable clear coat compositions include those disclosed in U.S. Pat. Nos. 4,650,718; 5,814,410; 5,891,981; and WO 98/14379.

Metal substrates coated by the process of the present invention may demonstrate excellent corrosion resistance as determined by salt spray corrosion resistance testing.

The invention will be further described by reference to the following examples. Unless otherwise indicated, all parts are by weight.

### EXAMPLES

### Example 1

### Cationic Resin and Curing Agent

A cationic amine salt group-containing acrylic resin, having a blocked aliphatic polyisocyanate curing agent mixed with the polymer, was prepared in accordance with Example B of U.S. Pat. No. 7,070,683.

### Example 2

### Pigment Paste

A pigment paste for use in compositions of the present invention was prepared as follows using the ingredients listed below. The paste contained 10 percent by weight 2-mercaptobenzothiazole, based on the total weight of pigment solids:

| Material # | Ingredient | Parts by Weight |
|---|---|---|
| 1 | Cationic grind resin¹ | 657.29 |
| 2 | Deionized water | 1191.96 |
| 3 | Carbon Black pigment² | 37.28 |
| 4 | Sunfast Blue pigment³ | 18.64 |
| 5 | TiO₂⁴ | 258.99 |
| 6 | Yellow Iron Oxide⁵ | 683.78 |
| 7 | 2-mercaptobenzothiazole⁶ | 110.86 |
| 8 | Deionized Water | 41.20 |

¹Cationic grind resin prepared as described in U.S. Pat. No. 6,017,432 Column 14, Example IB, Part (ii) and Part (iii)
²Printex 200 carbon black beads available from Evonik Degussa
³Sunfast Blue phthaloblue pigment available from Sun Chemical
⁴Tiona RCL-9 TiO₂ pigment available from Millennium Inorganics
⁵Lemon yellow oxide pigment available from Hoover Color
⁶ROKON (2-Mercaptobenzothiazole) available from R. T. Vanderbilt

Materials #1 and #2 were preblended in a flat bottom metal container. Materials #3 through #6 were added sequentially to the mixture under a high shear cowels. The paste was mixed for 30 min. Materials #7 and #8 were added under low shear mixing and the paste was stirred until uniform. The paste was then transferred to a RED HEAD medial mill equipped with a water cooling jacket and using 2 mm zircoa media. The paste was then milled until a Hegman of at least 7 was observed.

### Example 3

### Epoxy Microgel

A microgel for use in compositions of the present invention was prepared as follows using the ingredients listed below.

| | Raw Material | weight | solids | equiv. |
|---|---|---|---|---|
| A | D.E.R. 732¹ | 639.48 | 639.48 | 2.0301 |
| | Bisphenol A | 156.44 | 156.44 | 1.3723 |
| B | Benzyl dimethylamine | 1.50 | | |
| | subtotal | 797.42 | 795.92 | |
| C | JEFFAMINE D400² | 167.42 | 167.42 | 0.7518 |
| | TOTAL | 963.34 | 963.34 | |
| D | acetic acid | 18.93 | 0.00 | 0.3152 |
| E | Deionized water | 1129.05 | | |
| | 85% EPON 828 in butyl | | | |
| F | CELLOSOLVE³ | 81.06 | 68.90 | 0.3665 |
| G | Deionized water | 1192.22 | | |

¹Reaction product of epichlorohydrin and polypropylene glycol, commercially available from the Dow Chemical Company.
²Polyoxyalkylene amine available from Huntsman Corporation
³Polyglycidyl ether of Bisphenol A available from Shell Oil and Chemical Co, in ethylene glycol butyl ether.

Charge A was added to a suitable reaction vessel and heated to 130° C. Charge B was added, and the reaction mixture held at 135° C. until an epoxy equivalent weight of 1210 (on solids) was achieved. The mixture was allowed to cool to 95° C. Then charge C was added, and the mixture held at 95° C. until an extrapolated viscosity of H (50% in propylene glycol methyl ether) was achieved. Then the reaction mixture was dropped into a mixture of charges D+E and mixed at 65° C. for 30 min. Charge F was added and the mixture held at 75-80° C. for 4 hrs. Finally, charge G was added and the mixture held for 30 min. The reaction product had a solids content of 30 percent by weight and an acid equivalent weight of 60.05.

### Example A

### Control Example

This Control example describes the preparation of a cationic electrodeposition paint with no 2-mercaptobenzothiazole added to the pigment paste. The electrodeposition paint composition was prepared from a mixture of the following ingredients:

| | |
|---|---|
| Resin of Example 1 | 1807.4 g |
| Pigment Paste¹ | 315.8 g |
| Deionized Water | 1776.8 g |

¹pigment paste commercially available as CP982 from PPG Industries, Inc.

An electrodeposition bath was prepared by charging the resin of Example 1 and predispersing it in deionized water. The pigment paste is then predispersed using deionized water in a separate container. After stirring for several minutes to create a diluted uniform, low viscosity paste blend, it is then added to the resin under agitation and stirred until the paint has become a uniform composition.

Thirty percent by weight of the paint is removed by ultrafiltration and replaced by deionized water.

### Example B

This example describes the preparation of a cationic electrodeposition paint in accordance with the present invention, having 10 percent by weight (based on the total weight of pigment solids) 2-mercaptobenzothiazole added to the pigment paste. The electrodeposition paint composition was prepared as in Example A, except that the pigment paste was replaced with the pigment paste of Example 2.

### Example C

### Control Example

This Control example describes the preparation of a cationic electrodeposition paint with no 2-mercaptobenzothiazole added to the pigment paste. The electrodeposition paint composition was prepared from a mixture of the following ingredients:

| | |
|---|---|
| Cationic Resin¹ | 1735.8 g |
| Epoxy Microgel of Example 3 | 71.6 g |
| Pigment Paste² | 315.8 g |
| Deionized Water | 1776.8 g |

¹acrylic cationic resin blend commercially available as CR 756 from PPG Industries, Inc.
²Pigment paste commercially available as CP982 from PPG Industries, Inc.

An electrodeposition bath was prepared by charging the cationic resin and predispersing it in deionized water. Next, the microgel is added under agitation and stirred until uniform to create a resin blend. The paste is then predispersed using deionized water in a separate container. After stirring for several minutes to create a diluted, uniform, low viscosity paste blend, the paste is then added to the resin blend under agitation and stirred until the paint has become a uniform composition.

Thirty percent by weight of the paint is removed by ultrafiltration and replaced by deionized water.

### Example D

This example describes the preparation of a cationic electrodeposition paint in accordance with the present invention, having 10 percent by weight 2-mercaptobenzothiazole added to the pigment paste. The electrodeposition paint composition was prepared as in Example C, except that the pigment paste was replaced with the pigment paste of Example 2.

The steel panels used for the electrodeposition of the coating compositions of Examples A to D are available from ACT Test Panels LLC of Hillsdale, Mich. as part number APR33225. The panels were ACT Cold Rolled Steel and are 4 inches×12 inches×0.032 inches (10.16×30.48×0.08 cm). They were pretreated with B952 P90 DIW.

A cylindrical plastic coating tube 4¾″ inches (12.1 cm) diameter and 15 inches (38.1 cm) height was equipped with a magnetic stirring bar and a stainless steel heating/cooling coil, which also acts as the anode for electrodeposition.

The coating conditions were:

Bath temperature: 90° F. (32.3° C.)

Voltage: 200-250 volts

Amperage: 0.7-1.0 amps

Coating time: 2 minutes

The panels, after coating with the electrodeposited composition, were removed from the bath and rinsed with a spray of deionized water, hung vertically to drain away excess water, and baked for 30 minutes at a temperature of 350° F. (176.7° C.) in an electric oven. A hard and smooth organic coating resulted with a film thickness of 0.85 mils, or 0.0085 inches (21.6 microns).

### Testing

### Corrosion Testing

Coated 4″×6″ B952 P90 panels were scribed (3 inches) and placed in a salt fog chamber for periods of 250 hrs/500 hrs/750 hrs/1000 hrs. in accordance with ASTM B117. The duplicate exposed panels were inspected for blistering, filiform corrosion, and any delamination from the scribe. This measurement is reported in millimeters (mm) across the scribe. The higher the numbers, the greater the corrosion across the scribe line.

TABLE

| Exam- | Salt Spray | Salt Spray | Salt Spray | Salt Spray |
|---|---|---|---|---|
| ple | 250 hrs | 500 hrs | 750 hrs | 1000 hrs |
| A (Con- | 4.0-5.0 mm | 8.0-10.0 mm | 10.0-12.0 mm | 17.0-19.0 mm |
| trol) | | | | |
| B | 4.0-6.0 mm | 6.0-8.0 mm | 9.0-13.0 mm | 10.0-15.0 mm |
| C (Con- | 2.0-5.0 mm | 6.0-8.0 mm | 15.0-17.0 mm | 15.0-20.0 mm |
| trol) | | | | |
| D | 2.0-3.0 mm | 5.0-8.0 mm | 10.0-12.0 mm | 14.0-17.0 mm |

We claim:

1. A curable, electrodepositable coating composition comprising:
(1) a resin component containing an active hydrogen-containing, cationic salt group-containing resin comprising an acrylic, polyester, polyurethane and/or polyepoxide polymer;
(2) an at least partially capped polyisocyanate curing agent; and
(3) an additive composition comprising 2-mercaptobenzothiazole dispersed in a polymeric component.

2. The composition of claim 1, wherein the cationic salt group-containing resin of component (1) comprises an acrylic polymer.

3. The composition of claim 1 wherein the cationic salt groups are amine salt groups.

4. The composition of claim 3 wherein the polymeric component in the additive composition (3) comprises a grind vehicle.

5. The composition of claim 1 wherein the resin component (1) further comprises a microgel derived from a polyepoxide.

6. The composition of claim 1 wherein the additive composition (3) further comprises a pigment.

7. The composition of claim 6 wherein the 2-mercaptobenzothiazole is present in the additive composition in an amount of up to 25 percent by weight, based on the total weight of pigment solids in the additive composition.

8. The composition of claim 7 wherein the 2-mercaptobenzothiazole is present in the additive composition in an amount of up to 10 percent by weight, based on the total weight of pigment solids in the additive composition.

9. The composition of claim 6 wherein the pigment comprises carbon black, TiO₂, yellow iron oxide, and/or phthalo blue.

10. The composition of claim 1 wherein the polymeric component in the additive composition (3) comprises an acrylic, a polyester, a polyurethane, a polyether, and/or a polyepoxide.

11. A process for applying a coating to a metal substrate comprising:
(a) electrophoretically depositing on the substrate a curable, electrodepositable coating composition comprising:
(1) a resin component containing an active hydrogen-containing, cationic salt group-containing resin comprising an acrylic, polyester, polyurethane and/or polyepoxide polymer;
(2) an at least partially capped polyisocyanate curing agent; and
(3) an additive composition comprising 2-mercaptobenzothiazole dispersed in a polymeric component; and
(b) heating the substrate to a temperature and for a time sufficient to effect cure of the electrodepositable composition.

12. The process of claim 11, wherein prior to electrophoretically depositing the electrodepositable coating composition on the substrate, the substrate surface is subjected to a pretreatment process.

13. The process of claim 11 wherein the metal substrate comprises aluminum, aluminum alloys, cold rolled steel, galvanized (zinc coated) steel, electrogalvanized steel, pickled steel, and/or zinc-iron alloys.

14. The process of claim 11, wherein the cationic salt group-containing resin of component (1) in the electrodepositable coating composition comprises an acrylic polymer.

15. The process of claim 11 wherein the cationic salt groups are amine salt groups.

16. The process of claim 11 wherein the resin component (1) further comprises a microgel derived from a polyepoxide.

17. The process of claim 11 wherein the additive composition (3) further comprises a pigment.

18. A process for preparing a curable, electrodepositable coating composition comprising:
(1) combining (i) a resin component containing an active hydrogen-containing, cationic salt group-containing resin comprising an acrylic, polyester, polyurethane and/or polyepoxide polymer, with (ii) an at least partially capped polyisocyanate curing agent to form a reactive mixture;
(2) adding to the reactive mixture an additive composition comprising 2-mercaptobenzothiazole dispersed in a polymeric component;
(3) adding a catalyst composition to the reactive mixture; and
(4) diluting the reactive mixture with water to a solids content of 10 to 30 percent by weight, based on the total weight of the reactive mixture.

19. The process of claim 18, wherein after diluting the reactive mixture with water, a portion of the reactive mixture is removed by ultrafiltration and replaced with deionized water.

20. The process of claim 18 wherein the additive composition further comprises a pigment.
